(19) United States
(12) Patent Application Publication
(10) Pub. No.: US 2008/0133316 A1
(43) Pub. Date: Jun. 5, 2008

(54) Method and software application which evaluates the position of a firm in the market

(75) Inventor: Soumodip Sarkar, Evora (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DE EVORA, Evora (PT)

(21) Appl. No.: 11/606,051

(22) Filed: Nov. 30, 2006

(51) Int. Cl. G06Q 10/00

(52) U.S. Cl. 705/10

(57) ABSTRACT

The present invention provides a firm's diagnosis which evaluates the position of a product or single product firm in the market according to its strategy of differentiation. Based on an Integrated Innovation Model (IIM), a system of data recovery (for example, a questionnaire) allows making a diagnosis of firms. Based on the averages of each of three dimensions used in the model (competitive pressure, differentiation and outcome), it calculates the respective position in those dimensions. After this, the diagnostic provides firm's position in the four spaces of the IIM. The three dimensions of the model are divided into subdimensions, and then a comparison is made between each dimension and the respective subdimensions. Data recovery could be repeated for several firms and, with the storage of results, which can then be used for benchmarking by comparing a firm to the respective industry and also to the high performing firms in the industry. Software based on the model allows us to make not only the complete diagnostics of firms, but also to analyse the dynamics inherent to innovation and markets and serve as an educational framework. Both the model and the software solve a need not just in innovation consultancy but also as a pedagogical tool.

### FIELD OF THE INVENTION

The present invention is related to a model of innovation which permits a firm's diagnostics, evaluating the position of the firm in the market according to its strategy of differentiation (for simplicity, every time we refer to “product” or “firm”, we imply a product or a single product firm). This invention is the process of passing from the existing model to a diagnostic report. It is made with a system of data recovery, for instance a questionnaire distributed to firms, a questionnaire for consumers to understand their perception on the product and/or also other external data which therefore calculates the averages of the dimensions of the model, and also another relationships linked to the firm's position.

### BACKGROUND OF THE INVENTION

Innovation literature is vast, both in its scope and depth, with different authors choosing the prudent path of focusing on certain aspects of innovation. The outcome of such focus depends on who is the actor and what is the focus on. For instance, the product manager is more concerned with product innovation, while the CEO wants to know the outcome of such an innovation. The consultant may choose to look at the organizational preparedness for innovation while the economist may wonder at the wider implications of new products in the market place. The marketing manager will push for new marketing channels or more effective branding while the design engineers focus on greater appeal or better usability of the product.

In economics students learn of different types of markets, namely competitive markets, monopolistic competition, oligopoly and monopoly. Each of these market structures are characterized by a set of behavioural assumptions, such as the ease of entry and exit into the industry, the number of firms, degree of homogeneity of the product etc. Although the literature is rich (see Tirole, 1988) in the many strategic variables of firms (all quantifiable), price as a choice variable is considered to be the most important strategic tool for profit maximizing firms. The strategic variable of choice in each market is the price (or its inverse, quantity). Simplistically put, what characterizes each market is the degree of freedom a firm has in that market to set its own price.

Product differentiation enables firms to escape from the gravitational force of marginal cost pricing allowing firms to charge a premium over costs (the Bertrand Paradox in economics, if consumers perceive two goods as being identical, and then assuming that marginal costs were same and constant, then marginal cost pricing would be the only equilibrium). Frequently differentiation is introduced in the models usually via space where space is used as a metaphor for product differentiation (see, for example, Hotelling, 1929) or via different demand elasticities.

In the management literature, specifically management strategy, there is a plethora of relatively simple and intuitive models for both managers and consultants to choose from. Most of these models provide insights to the manager which help in crafting a strategic plan consistent with the desired aims. Indeed most strategy models are generally simple, wherein lie their virtue.

Over the years, academics and consultants have devised their own models to enable firms to see the ‘where’ (firms are situated) to prepare them to devise methods to achieve objectives and foresee coming changes for them to adapt and evolve. Among the many models are the PEST analysis, the five competitive forces analysis, value chain analysis, seven McKinsey S's analysis, the driving forces analysis, the Ansoff matrix, the BCG Growth-Share matrix, Porter's Generic Strategies, and the Space Matrix (ten Steve et al., 2003). More recently Tesmer (2002), has come up with an archetypal model, which tries to match organisations with market environments.

Given the conceptual approach of most of these models, strategy model rarely deal with innovation as an explicit variable. However innovation or new products or markets is often built into some of the models as a dimension. Geared towards helping the manager devise competitive strategies, the 2×2 conceptual matrices are designed to help the firm understand firm and market position along the dimensions chosen by a particular model (Ansoff, 1957).

Innovation literature has been enriched along other dimensions as well, mostly on the dynamics of the innovation process described by the product life cycle. The idea of a product lifecycle in technological innovation research was articulated by Abernathy and Utterback (1978) who noted that the nature of innovation around a product could vary during its life time. The product life cycle trajectory begins with the emergence of a new product characterized by experimentation and learning about and by users and then the subsequent stages of the life cycle is based upon the economics of innovation, from novelty products to mass production and commoditization. The transition from novelty products to mass production is marked by the emergence of a dominant design.

The technology life cycle is also described by an “S Curve” when the product reaches its technical evolution towards a physical limit (see Foster, 1986). The diffusion of the product follows a similar pattern. Given appropriate simplifying assumptions both technical progress and market diffusion through time can be expected to approximate a cumulative logistic distribution (hence the term S-curve). The technology proceeds up an S-curve through regular innovation. As it proceeds up that S-curve, it diffuses to fill the market circumscribed by the limits of the needs it can satisfy.

Christensen (1997) further enriched our understanding of product innovation as a result of his query of whether a given innovation is sustaining or disruptive to the established companies in a given industry. Sustaining innovations refer to innovations contribute to improved performance in existing products and thereby a strengthening of each respective company's position on the market, similar to incremental innovation. Disruptive innovations on the other hand are almost ‘stealth’ innovation, that are due to products that at least on some attributes are worse than existing product, but leads to the failure of leading companies in the industry.

Innovation literature, while rich in typologies and descriptions of innovation dynamics is very often technology focused. Most research on innovation has been devoted to the process (technological) of innovation, or have otherwise taken a ‘how to’ (innovate) approach. There remains a strong need, for the researcher and the manager alike to have an intuitive feel for the innovation—market linkages.

The need for a holistic understanding of innovation was solved with the Integrated Innovation Model (IIM), already published in an article (Sarkar, 2005), where we can understand innovation in an integrated manner, with the interaction of several different variables. The IIM also permits an understanding about the dynamics of innovation with relationship to market outcome. This model is a framework of innovation, a market based approach to understanding innovation, its market outcome dynamics and product life cycle, enriched by the understanding of three (mutually non exclusive) fields of study—industrial organization, strategy and innovation. This model allows for a diagnostic of firms, which also is one objective of this patent.

Some diagnostics exist, mostly by consultants often without any theoretical support. Below are a couple of examples of what are considered to be more structured innovation diagnostics.

In their book, Making Innovation Work, Davila et al. (2005), defend an approach to metrics that they call “the balanced scorecard for innovation.” According to these authors: “A basic tenet of the balanced scorecard is that the measurement system is only as good as the underlying business model. The business model describes how the company will be innovative and how it will generate value from innovation [ . . . ] The richer our understanding of the innovation processes, the better our business model will be and the derived measurement system will provide a more informed management of innovation; By making the business case for innovation investments, managers can integrate innovation impacts into their business strategies.”

The innovation balanced scorecard employs a business model that focuses on 4 key areas—inputs, processes, outputs and outcome:

Inputs are resources devoted to the innovation effort. The resources include personnel, money, infrastructure and time. Besides explicit measures, the scorecard attempts to include intangibles like motivation and corporate culture.

Processes involve the use and transformation of inputs into outputs. Thus the organization's creative processes, project execution as well as integrated execution (the latter tracks aggregate performance of all projects).

Outputs measures are the result of innovation efforts are focused on key characteristics such as whether the company has superior R&D performance, more effective customer acquisition or better customer loyalty.

Outcome measures employed in the innovation balanced score card differ from outputs in that they describe value creation. The outcome measures attempt to capture how innovation effort is translated from outputs into value for the company as well as the net amount of the value contribution.

As explained by the authors:

The innovation metrics designed by the Davila et al. (2005) emphasize that the business model cannot be rigid and needs to vary based on different types of innovation and business processes.

Muller et al. (2005) take a somewhat different approach to innovation metrics, using capability, resource and resource views to come up with a metrics that can assess and develop a company's capacity for innovation. The authors explain each view as follows:

Resource view. Companies must balance optimization (tactical investment in the existing business) and innovation (strategic investment in new businesses). The resource view addresses the allocation of resources to effect this balance. The resource inputs are capital, labour, and time. Output is the return on investment in strategic innovation;

Capability view. The capability view assesses the extent to which the company's competencies, culture, and conditions support the conversion of innovation resources into opportunities for business renewal. The inputs of this capability view are the preconditions for innovation, i.e. the extent to which a company's skills, tools, culture, and values are adapted to innovation. For example, does the company consider past demonstrations of innovativeness when selecting new recruits? Outputs include the development of new skills and knowledge domains that spawn innovation as well as the number of strategic options (i.e. opportunities to significantly advance an existing business or invest in a new business);

Leadership view. The leadership view assesses the degree to which a company's leadership supports innovation. As such, it evaluates leaders' involvement in innovation activities, the establishment of formal processes to promote innovation, and dissemination of innovation goals.”

Innovation processes (such as incubators, innovation markets, venture funds, and innovation incentives) interlink with the resource view and the capability view.

Other authors and consultants have devised different sets of diagnostics, depending upon measurement objectives and the conceptual model on which the metrics are based. For instance the consulting firm Innosight has devised a set of diagnostics based upon Clayton Christensen's concept of disruptive innovation.

Their diagnostics are based on four basic principles—focusing on what firm wants to do, how to be attractive for the worst clients and understanding where consumption is constrained. Thus they come up with three different diagnostics.

The first is the Customer diagnostic, assessing to identify possible disruptable markets. They do this with the following indicators: “people complaining about overly complex, expensive products and services”, “features that are not valued and therefore are not used” and “Decreasing price premiums for innovations that historically created value”. It is also important to pay attention on nonconsumers in every markets.

The second diagnostic is the portfolio diagnostic. It assesses if any potential innovations could have success in the market, “looking at the technological characteristics of the innovation and at the potential business model by which the innovation might be brought to market.”

The final diagnostic is the competitor diagnostic. This one assesses competitors to “ensure that the selected opportunity takes unique advantage of their weaknesses and blind spots”. It will analyse if competitors will respond or not to the new innovation, or even if they are capable to do it.

### BIOLIOGRAPHIC REFERENCES

Tirole J (1988) The Theory of Industrial Organization. The MIT Press;
Hotelling H (1929) Stability in competition. Economic Journal 39: 41-57;
Have S T, ten Wouter H, Frnas S, van der E M (2003) Key Management Models. Prentice Hall—Pearson Education Limited;
Tesmer J A (2002) Your Perfect Business Match: A Groundbreaking Approach to Surviving and Thriving in Today's Business Battleground. Career Press;
Ansoff I (1957) Strategies for Diversification. Harvard Business Review 35(5):113-124;
Abernathy W J, Utterback J M (1978) Patterns of Innovation in Industry. Technology Review. 30(7): 40-47;
Foster R (1986) Innovation: The attacker's advantage. London. MacMillan;
Christensen C M (1997) The Innovator's Dilemma. Harvard Business School Press. Boston;
Sarkar S (2005) An Integration Model of Market Structures and Innovation Strategy. International Journal of Innovation and Entrepreneurship Management, Vol 5;
Davila T, Epstein M J, Shelton R (2005) Making Innovation Work: How to Manage It, Measure It, and Profit from It. Wharton School Publishing;
Muller A, Välikangas L, Merlyn P (2005) Metrics for innovation: guidelines for developing a customized suite of innovation metrics. Strategy & Leadership 33(1) pp. 37-45.

### BRIEF DESCRIPTION OF THE DRAWINGS

For a better understanding of this invention, reference is made to the following description, in connection with the drawings in which:

FIG. 1 illustrates, in a graphic form, the Integrated Innovation Model (IIM) in the four spaces.

FIG. 2 illustrates, in block diagram form, the algorithm of the Integrated Innovation Model (IIM).

FIG. 3 illustrates one of the dynamics of the model: consequences of the life cycle.

FIG. 4 illustrates how the model maps the integrated innovation space.

FIG. 5 illustrates, in block diagram form, the software menu structure.

FIG. 6 illustrates the visual aspect of the questionnaire that can be presented to the IIM software user.

FIGS. 7-15 illustrate, in a graphic form, several examples of output graphic representations.

### SUMMARY OF THE MODEL

The model describes a firm (or a product) along four dimensions: an external market dimension, a strategic orientation dimension, and two outcome dimensions (in most cases we shall refer to three dimensions since two of them are market outcome dimensions). These four dimensions together then define four spaces: an archetype space, a strategy space, an outcome space and a market space.

Archetype Space: A firm (or product) is situated in a market (product) space determined by two dimensions: an external (market) and an internal (strategic) dimension. The external market dimension, is a ‘given’ to the firm, and is the competitive market pressure it faces. The second dimension is a strategic orientation variable, which here is represented by the degree of innovation-product differentiation.

The Strategy Space: The second of our four spaces, positions a product or a firm in terms of its strategic orientation (innovation/product differentiation) and the resulting market outcome. These two variables are connected via a behavioural relationship.

The Outcome Space: The outcome space traces out the relationship between two market outcome variables. The outcome space is the outcome of the firm's strategic positioning. The market outcome variables can also be separately treated as two dimensions—market share and profits, the two being connected via a behavioural relationship.

The Market Space: This space defines the competitive pressure faced by the firm and the market outcome. The market outcome of the firm, is related to its strategic orientation.

Besides the four dimensions of the model, there are other variables that impinge on the firm's positioning.

These variables include price, market size and growth, productivity, costs, marketing and profit margins. With regards to a particular positioning of the firm, these factors appear as parameters, hence changes in these variables would affect the firm positioning in the integrated space.

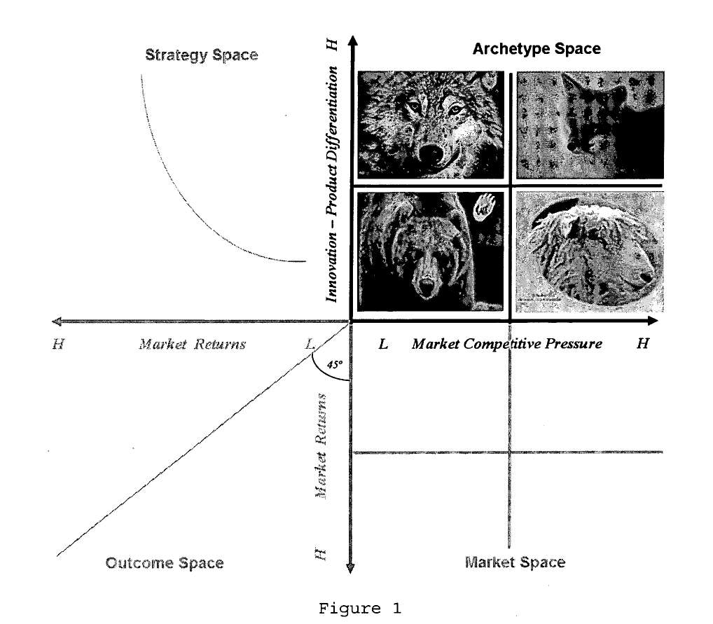

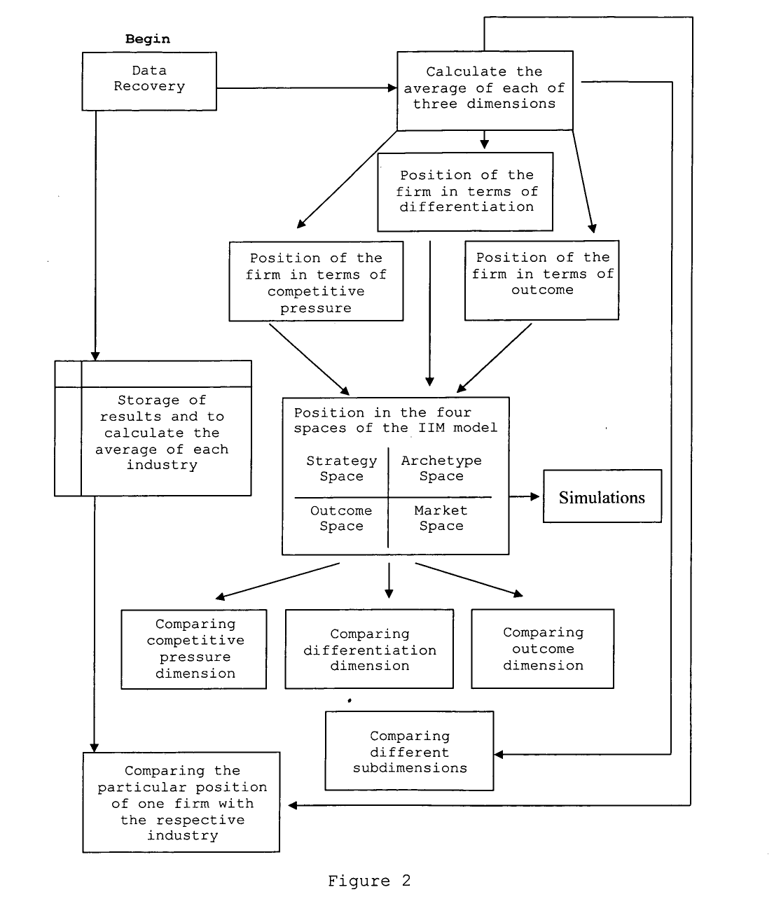

The visual representation of the model is a four quadrant matrix that positions a firm (or a product) in terms of its external market dimension, its strategic positioning and the market outcome. The four quadrant model, presented in FIG. 1, unites the four environments in a single analytical framework.

In the first and north-east quadrant which describes the archetype space, the external market dimension in which a firm operates is represented by the degree of competitive market pressure on the horizontal axis. A product or firms located further to the right are under increasing competitive pressure often represented by an increase in the number of firms in the industry. Drawing a parallel to economic theory, moving along horizontally to the right on the competitive pressure axis implies a decrease in the freedom for the firm in setting the price. Thus own price elasticity of demand increases, in absolute terms, with an increase in the competitive pressure.

The vertical axis in the archetype space measures a firm's strategic orientation. In the innovation context (of the general framework), the strategic orientation is an innovation-product differentiation strategy. Note too that

other than improvements in product characteristics, such as branding, after sales services, bundling, pricing strategy can all help at least for the short term, in creating a differentiation strategy.

Thus there are a number of elements which define the strategic orientation of a firm facing a particular external (market) environment and these elements of strategic orientation depend upon the specific industry under study.

Moving anti-clockwise, the strategy space gives the trade off between a firm's strategic orientation and market return. While the archetype space describes a firm according to the coordinates of an external (market)-internal (strategic) relationship, the strategy space defines its position given the market outcome of its strategic orientation. The second quadrant therefore describes a strategy space where the two variables innovation and market outcome are connected via a behavioural relationship.

The market outcome of the firm in its competitive environment can be variously represented by a variable such as sales, market share, margins or profits, with a westward or outward movement away from the origin representing an increased level of market share (or other outcome variable). A generic pay-off function represented by upward sloping, concave surfaces traces out the relation between the two dimensions. These curves represent the trade off of activities associated with a given degree of market pressure, between the strategic orientation pursued and the outcome of that strategy. In general, there is a positive relationship between the strategic orientation (innovation/product differentiation) and the resulting market share in the industry. These curves are called the innovation—pay-off (IP) curves in the model. The exact curvature or elasticity of these IP functions is industry specific. These IP curves, associated with a given degree of market pressure, can shift either temporally due to different factors including evolving product and labour market conditions, technological changes and (disruptive) innovation.

Hence coordinates of a product in the strategy space give the market outcome enjoyed by the firm in a given competitive environment that is the result of the degree of innovation or product differentiation pursued. Ceteris paribus, a higher level of product differentiation by a firm would lead to an increase in market outcome (sales, market share or profits).

The third quadrant describes the outcome space, but in an effort to keep the model simple, most times only one sub dimension is used to represent firm outcome given its strategic orientation (innovation strategy). This space maps market outcome measured by sales, market share or profits, on to itself via the 45° line. This device enables us to study in the final southeast quadrant, the correspondence between returns and competitive pressure.

However, when there is a need for more complete analysis the outcome space can incorporate two distinct variables (sub dimensions), for instance market share and profits. These two variables are interrelated via a behavioural relationship such as a generic concave curve. This implies that an increase in market share would increase profits at a diminishing rate. Explicitly introducing two outcome variables permits a richer analysis of firm diagnostics. For instance it permits an understanding of why firms with equal market shares may have different profits. This can then be used to analyse cases involving similar market pressures and product differentiation but different outcomes. Changes in factors such as price, market size and market growth, productivity, factor costs, marketing or profit margins would cause corresponding shifts of the curve relating the two outcome variables. All this permits more complete and richer dynamic analysis of innovation and market outcome.

The fourth quadrant maps the external environment to market returns for a given strategic orientation (innovation). This space is called the market space, which locates the market outcome for a given degree of competitive pressure. The market outcome of the product (single product firm), is in turn related to the degree of product innovation/differentiation via the integration of the strategic space and the outcome space.

FIG. 1 presents our integrated model as a four quadrant graphical framework. The visual representation of the model is a four quadrant matrix, numbered I through IV, moving anticlockwise where each quadrant corresponds to one of the four environments already defined. In the first quadrant, the archetype space, we have the product-market environment given by the market pressure and the degree of innovation-product differentiation. The second quadrant locates the market outcome as a result of the innovation-product differentiation strategy employed. This is the strategy space. The third quadrant employs the 45° line that enables us to study in the fourth quadrant the market environment, which gives the relationship between market outcome and the market competitive environment for a given degree of innovation or product differentiation.

Archetype space—We divided this first quadrant into four different market archetypes, according to the degree of competitive pressure in the market and to the degree of innovation/product differentiation. On the horizontal axis, as we move to the right, the industry gets characterised by an increasing number of firms and is under a greater competitive pressure. A vertically upward movement in this space on the other hand, implies an increase in the degree of product or brand differentiation of the firm. The four market archetypes: the bear, the wolf, the fox and the sheep.

Bear archetype is characterised by few firms offering products or services that are not very differentiated. The reduced number of firms operating in such markets is often due to licensing requirements or ownership of a natural resource. The bear market is generally not characterised by free entry and exit. Due to the low degree of competition, market share tends to be high. However this may not translate into correspondingly high profits, which other than market size depend on other factors such as productivity, efficiency, cost and pricing structure. Many natural monopolies like utility companies are bears, as too are various public enterprises. Firms in bear markets tend to have rigid hierarchical organisations that reflect in their lethargic response to external changes. The protected nature of the market implies that firms characterized as bears tend to be inefficient and also not client oriented. Their survival depends on the extent to which they can protect their market space from encroachment by other potential entrants, and guard zealously their monopoly rights.

Wolf market archetype is characterised by the presence of few firms offering a similar product or service. However unlike bears, wolf products are highly innovative. The reduced number of firms operating in the wolf industry can be the result of one or more factors such as—high entry costs, licensing requirements, ownership of a resource, patents, technological supremacy, etc. A technologically advanced product such as the Apple ipod would be a good example of a wolf product. Due to their highly innovative and differentiating characteristics, wolves have few direct competitors and consequently enjoy high market shares. This often translates into higher profits but the temporal profit window is determined by the extent to which wolves can be copycatted. This in turn is determined by the sources of innovation of wolf products and the extent to which these sources enjoy some form of sustainability (technological superiority, knowledge, patent ownership etc.). Product sophistication and not price is the distinguishing characteristic that consumers seek in wolf products. To remain as wolves, these firms have to constantly invest in innovation and in the quality of their human resources. Organizational agility is the key to the sustainability of the innovation strategy. Constantly gazing the horizon for likely competitors and imitators, wolves are aggressive and protect their market share and brand name fiercely. They are also quick to respond and attentive to their client needs and try to maintain client fidelity. Teamwork and creativity are the hallmarks of the wolf organization. Many new, breakthrough electronic, telecommunications and sometimes household appliance products with new and superior functionalities can be classified as being in the wolf market as well as software firms. In general technology intensive products, in the early part of their product life cycles, can be categorized as wolves.

Fox products are highly differentiated as firms try to distinguish themselves in the crowded market space. Firm profits may or may not be significant, depending upon the degree of product differentiation and also on the market size. Foxes face elastic demand curves and they tend to create niche markets. Given the competitive choices available, fox clients are price sensitive so price can be an important strategic variable. Considerable resources can be spent by foxes in advertising in particular and securing client fidelity in general. Product differentiation strategy in such cases is often via marketing, branding differentiation strategies or pricing packages. Fox organizations tend to be lean and quick to respond to changing market conditions. Individual creativity finds an important role in the organizational culture. In the world of business there are numerous examples of firms who could be called foxes in their effort to create market niches through product innovation or brand differentiation. For instance, the computer industry can be considered as an example of the fox market, in their continuous effort to create, for instance in the desktop market, a brand name. The market for clothing, consumer goods, and MBA programs are some examples of fox markets. Various types of consultancy services and in general many service sector SME's can be described as being in the fox market.

Sheep market is characterised by a large number of firms offering a product or service whose characteristics are very similar. At the extreme, this market is characterised by many firms selling a homogenous product, akin to perfectly competitive markets in economics. Firm entry and exit is easy and relatively inexpensive in this market archetype. An individual firm or product in the sheep market, faces an own price elasticity of demand that is relatively high in absolute terms. Sheep products are seen as commodities with very little to differentiate among the choices available in the market, or are at the end of the product life cycle. The key to their survival lies in providing products and services at low prices and catering to large markets. Just as the firms themselves, sheep market shares tend to be small. Firms in this highly competitive market tend to be price takers, that is, they have little power to individually determine the price for its homogeneous product offering. Attention to controlling costs is the focus for survival with sporadic attempts at product differentiation through branding and attention to service. Tasks are clearly defined in sheep markets. The agricultural sector can be considered an example of such markets. Small scale construction or specialised service firms like plumbing etc. is another example. Many small and medium enterprises would fall under the sheep market archetype.

Innovation-Market Dynamics—Besides the diagnostics that the model permits, the integrated model can also explain some dynamics of innovation and market outcomes, that have consequences for firms and on their decisions of innovate. The study of dynamics is effectively of great important aspect. Firms in different market archetypes metamorphose due to a wide variety of forces, both due to changing internal and external market environment. Our model can explain how these forces lead firms to evolve over time, and help firms design strategies to predict and to emerge on top of these forces.

For example, a protected bear in a market characterised today by a few firms and low degree of differentiation, could suddenly find itself surrounded by foxes and has to learn to adapt rapidly and grow. It has to learn to live in a market space with a larger number of firms furiously trying to fend off competitors and desperately trying to create market niches. The lone wolf, highly innovative and highly profitable could wake up to see an upstart new born with a business model that suddenly threatens its market leadership. A few missteps could turn this wolf into irrelevance.

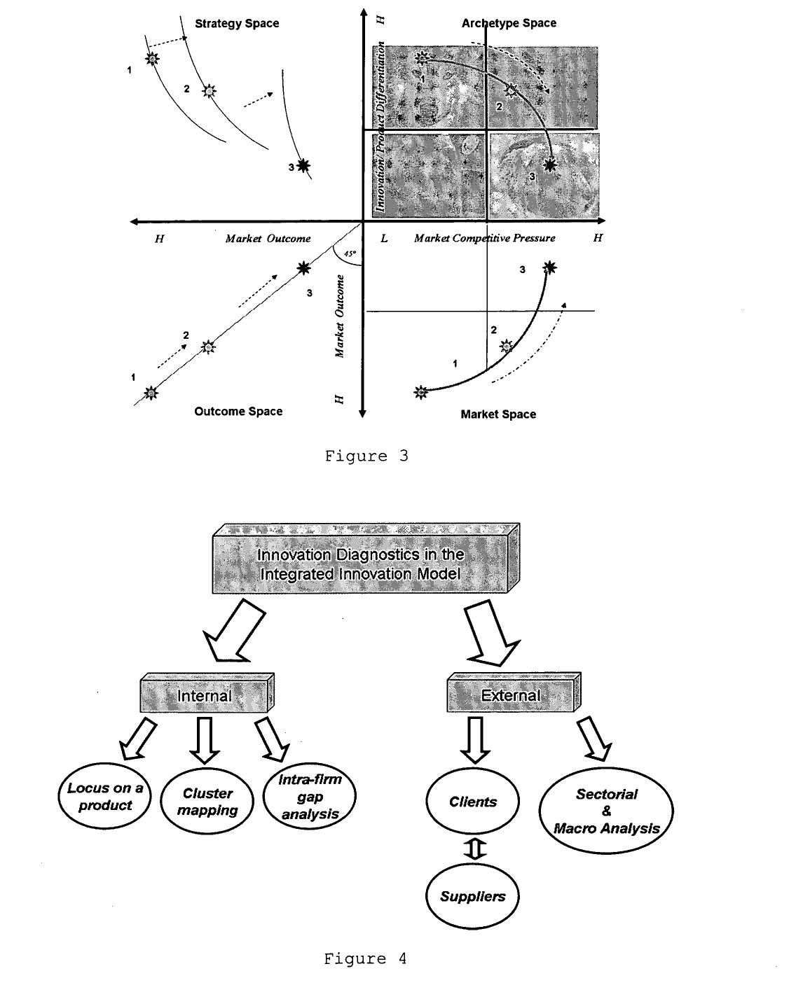

We can study, for example, an innovative firm, a wolf enjoying considerable market domination, high margins and high profits, which loses its position due to new competitors. We can analyze the consequences of the shrinking life span of a product with the impending prospect of commoditization in the not too distant future. It is also interesting to study how a firm ‘fights’ to keep their innovative position. And, following the model of Clayton Christensen, we can analyse the consequence of disruptive innovation. The model permits many other analyses of real life dynamics. In FIG. 3 we have one such example, an illustration of a product life cycle in the context of the integrated innovation space.

### SUMMARY OF THE INVENTION

The present invention evaluates/diagnoses the position of the firm in the market, according to its capacity of differentiation/innovation, based on a system of data recovery (for example via a questionnaire distributed to several firms, a questionnaire for consumers to understand their perception on the product or also other external data). This is the diagnostic framework of this invention. It could be based on a previously prepared questionnaire or with another system of data recovery.

Another capacity of this invention is that one can perform simulations to help users to understand the dynamics inherent in innovation and markets, through specific software, that is also protected by this invention. The dynamics include the following “external” changes: the life cycle of a product, the entrance of new firms in the market hence increase in competition, the continuous innovation or the appearance of disruptive innovations. Simulations can also be performed with respect to the following ‘internal’ dynamics: This type of software simulations would be of great value not only to the manager to understand and predict future market evolutions but also as a pedagogical tool. Hence students can benefit greatly from an understanding of how changes in factors affecting the business environment (which take place constantly around us) change a products position in the market place and how a change of this position affects its market outcome. The software could also make simulations on Entrepreneurship and Innovation. Games can be played where a new entrepreneur can first locate the entrepreneurial project in integration innovation space and then simulating these changes.

### DETAILED DESCRIPTION OF THE INVENTION

The first aspect of the present invention, referred to previously, is the diagnostic of the position of the firm. The diagnostic is made with information about the firm. One of the possibilities is to obtain the information through the distribution of a questionnaire to several members of the firm (managers, directors and other workers), who respond to the questions (the number of questions could vary depending on the type of product or if it is a service). Automatically the software would perform the diagnostics, and calculate the average of each of three dimensions used in the model: competitive pressure, differentiation and outcome. Then, the position of the firm in each of the three dimensions is displayed.

With this it is possible to identify the position of the firm in the four spaces of the IIM model: the Archetype Space (combining the degree of competitive pressure and the degree of differentiation and innovation), the Strategy Space (combining the degree of differentiation and innovation with the results), the Outcome Space (combining two dimensions of results) and the Market Space (combining results with the degree of competitive pressure faced by firm).

In the Archetype Space is also calculated the position of the firm. This position is determined according to the relative degree of competitive pressure and the degree of differentiation the firm could be in the following archetypes: Wolf (innovation/high differentiation, low competition), Fox (high differentiation and competition), Bear (low differentiation and competition) and Sheep (low differentiation and high competition). Then, greater consideration is made regarding this position, in case the diagnosis places a product or single product firm in r close to the frontier of two or more archetypes.

The theoretical model offers a relationship between Archetype Space and Market Space, which is also then studied in the diagnosis.

Each of three dimensions could be divided into subdimensions (a cluster of questions to measure interesting variables in a given dimension), according with groups that are available with the information:

Dimension: degree of competitive pressure. Subdimensions: competition, price pressure and client pressure.

Dimension: degree of innovation/differentiation. Subdimensions: sustainability of differentiation, clients' perception, investment and knowledge.

Dimension: outcome.

Subdimensions: market share, financial performance and prestige.

Then, each of these subdimensions is compared with the respective dimension's average.

The subdimensions can be treated also as variables. And these variables, even those which are used in different dimensions, could be related or compared to each other. Another step of the process is to display these comparisons. As an example, there are comparisons such as client's perception vs the firm's sense of the degree of pressure; client's perception vs prestige; investment in differentiation vs sustainability of differentiation; or market share vs financial performance. These relations are also explained by this process.

The continuous data recovery of different firms allows to perform storage of results and to calculate the average of each industry for all the previous components related. So the process will allow also comparing the particular position of one firm with the respective industry.

Once the information is obtained, a process of comparisons can be made. First comparing the position of each firm with the industry in each of the three dimensions and in each of the four spaces; then comparing each of the firm subdimensions to the industry subdimensions results; and finally viewing if the behaviour between subdimensions is equal when comparing the results of firm with the results of the industry

Related to the description of the simulations that can be performed by this invention, they can be useful to help users understand the dynamics inherent in innovation and markets, through specific software. The dynamics include the following external changes: the life cycle of a product, the entrance of new firms in the market hence increase in competition, the continuous innovation or the appearance of disruptive innovations. Simulations can also be performed with respect to the following ‘internal’ dynamics: changes in cost structures due to both input cost changes as well as managerial costs, productivity changes, impact of marketing efforts, organizational efficiency improvements etc. This type of software simulations would be of great value not only to the manager to understand and predict future market evolutions but also as a pedagogical tool. Hence students can benefit greatly from an understanding of how changes in factors affecting the business environment (which take place constantly around us) change a products position in the market place and how a change of this position affects its market outcome. The software could also make simulations on Entrepreneurship and Innovation. Games can be played where a new entrepreneur can first locate the entrepreneurial project in integration innovation space and then simulating these changes.

This integrated model and the associated dynamic analysis can be a powerful tool for both management consultants as well as managers, permitting not just a look at the mirror, but also as a first step to designing effective strategy. Using a set of mapping tools one can locate a product (or single product firm) in one of the four market archetypes—the wolf, the bear, the fox and sheep. Then the mapping is executed for the entire integrated innovation space and not just the archetype space.

SOFTWARE MODEL—The complete process described in the previous section (Detailed description of the invention) can be carried out by software, included in the invention. Data recovery, average calculations and all previous comparisons are all made by the software.

With the integrated innovation framework in place, the mapping challenge is to position a single product firm, (or a product or service) in each of the four spaces—the archetype space, the strategy space, the outcome space and the market space. Complete diagnostics consist of three different and complementary approaches. The most important is a set of internal diagnostics in the form of a survey questionnaire. A second set, is an external survey, principally for clients of same and similar products as well as suppliers. The third set consists of using external (mostly macro) indicators which include sectorial studies (FIG. 4)

The internal diagnostics consists of a set of questions that maps the position of a firm in the integrated innovation space. The basic thrust of this diagnostic is not so much as a metrics for innovation, but to serve as a measurement tool to capture which of the four market archetypes a product is in and what are the outcomes of the innovation-differentiation strategy pursued.

The internal diagnostics permits three types of mapping. The first consists of mapping the locus of a product (or single product firm) in the integrated innovation space (archetype space, strategy space, outcome space and the market space). The second is cluster mapping, whereby, comparisons and benchmarking can be performed between a product (single product firm) with regards to a group of competing products (firms). The third set of mapping is an intrafirm-gap analysis, which permits the firm to analyze and understand divergences between variables within a particular dimension. All the three types are enabled by the same set of survey questions. The second component of the process is the use of this information to describe several dynamics of the IIM.

Process description—After the data recovery is completed the process starts with the position of the firm in each one of the four spaces. Then, according to the position in the strategy space, the process will assume one behavioural relation between differentiation and results. This relation depends on the elasticity and of the position of the curve.

Then, with some questions, will be simulated some scenarios that correspond to the different dynamics allowed in the model. Those questions should be related with the entrance of more firms in the market, with the continuous innovation made by the incumbent firm, the appearance of radical/disruptive innovations or the natural consequence of the life cycle in the market, among other dynamics. It will explore some aspects that the model could explain.

All of these developments will be then explained in an integrated form. It means that all the spaces will be dynamically studied.

The study of dynamics is effectively a great important aspect. While innovation remains the key to growth, innovative firms are being constantly upstaged by young new start-ups. CEO's watch with dismay as their most innovative products, fruit of years of research, design, planning and investment, hurtle their way into commoditization. And competition is not just from the ones you knew. Global challengers are coming up everywhere, and some from poorer developing economies.

This process also show some important issues related with the theme. As an example, it will be able to show situations where two firms that, although having similar degree of market pressure, have different outcomes in the market; or how firms with the same degree of differentiation have different outcomes.

Another feature of the software is to study consequences of Entrepreneurship and Innovation, again based on several tests. Thus the user can, via a series of questions, locate the firm that he or she is planning to set up in the integrated innovation space. Once the location of the entrepreneurial object (new enterprise) is known, using simulations, the entrepreneur can find out future movements of the new enterprise. For instance, what happens if there is an increase in raw materials, new firms enter the market, an increase in innovation expenditure by x %, etc.

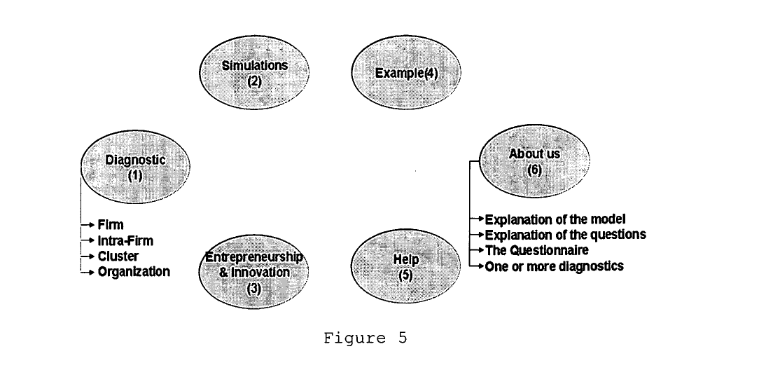

The software structure is described in FIG. 5, where the menus, that are available, provide the possible choices available to the Data Recovery System user.

The “Diagnostic” menu is divided into other submenus, according to the options in doing just the diagnostic for the firm or if exists an interest to make other diagnostics: intra-firm, with the cluster or make a diagnostic to the organization.

The “Simulations” menu is another important part of the software, which will explore the dynamics inherent to the IIM. After calculating the position of the firm in the model, with the firm diagnostic, the user is asked about some type of possible dynamics, for example, what happens if there are new entrants in the industry, if an innovative product will be copied or if will be expected an entrance from a disruptive product, between others. Then the software automatically demonstrates what happens in the context of the integrated innovation model (as explained earlier, for example in page 25).

The Firm Diagnostic ends when the position of the firm is made in IIM; Intra-Firm does the diagnostic between the several dimensions and sub-dimensions of the model; Cluster Diagnostic compares the results of the firm with the industry values; Organizational Diagnostic tries to identify a possible mismatch.

The “Entrepreneurship & Innovation” menu is based on the desire of a person to create a new firm. The entrepreneur via a series of tests (some of whose questions are similar to the firm diagnostics) would be able to locate the new entrepreneurial project in the integrated innovation space. Then the simulation part of the software would be rerun for the entrepreneur to know and understand the impact on his or her new project, of changes in the market place, or internal to the firm.

The “Example” menu shows an example of a questionnaire previously prepared, while “Help” will serve as a framework to help users how to navigate in this software.

“About us” is a menu where all things about the model are explained, since the origins of the model, to the questions that are used, the methods of data recovering and also to help users to choose if they are interested in one or more diagnostics.

### DETAILED DESCRIPTION OF THE PREFERRED EMBODIMENTS

The questionnaire is one of the possibilities for data recovering. All questions will be evaluated from 0 to 10, where 0 is the minimum value and 10 is the maximum value.

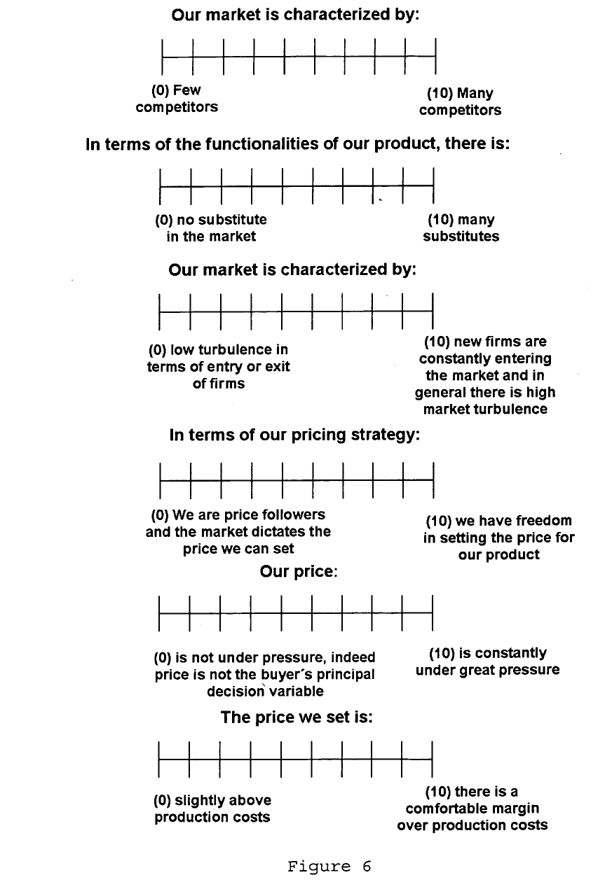

For the software user the questions can be presented as in FIG. 6.

As an example, the typical questions/answers of a questionnaire for a business company are:

### A) Degree of Competitive Pressure

Our market is characterized by: few competitors (0) many competitors (10)

In terms of the functionalities of our product, there is: no substitute in the market: (0); many substitutes (10)

Our market is characterized by: low turbulence in terms of entry or exit of firms (0); new firms are constantly entering the market and in general there is high market turbulence (10).

In terms of our pricing strategy: We are price followers and the market dictates the price we can set (0); we have freedom in setting the price for our product (10).

Our price: is not under pressure, indeed price is not the buyer's principal decision variable(0); is constantly under great pressure (10).

The price we set is: slightly above production costs(0); there is a comfortable margin over production costs (10).

### B) Degree of Differentiation/Innovation

Our product: is defined as having: standard, modular attributes (0); specialized features that are often proprietary (10)

We believe that: there are many firms who are providing something very similar to ours (0) our offer is really new representing a radical departure from any other firms' (10)

We believe that we offer to clients products that are: inferior to the competitors' products (0); better than our competitors' products (10)

Our products are: not dependent on any protection (0); protected by patent/copyrights/any special knowledge (10)

Our products: are not difficult to be copied (0); are not easily duplicated by other firms (10)

Our brand: plays a very small role in the customers mind when making product purchase (0); strongly influences and is decisive for the client (10)

The type of persons we need in our enterprises are: easy of recruit and doesn't demand much qualification (0); is difficult to recruit and demand additional training (10)

To maintain our market position: we don't need great investments in technology or personnel (0); we have to invest constantly in new ideas and technology to maintain our market position (10)

### C) Outcome

Our market share is: low and under great pressure (0) high and stable (10)

With regards to new markets: at the moment our objective is simply to survive (0); we are always trying to expand and explore new opportunities in markets (10)

Our clients: pay for our products: less than for our competitors' products (0); more than of our competitors' products (10).

Our margins before taxes are: small and under pressure (0); are comfortable and above industry average (10)

With respects to our investments: we make few investments and it doesn't change our market position (0); we make large investments and are satisfied with the returns from those investments (10)

We are: concerned with our low sales (0); we are satisfied with the regular increments of sales (10)

Our products have: less prestige than our competitors (0); enjoy much more prestige than our competitors (10)

Our clients' are: disappointed and may easily switch to our rivals products if we are not careful (0); they are very satisfied with what we have to offer (10).

Basically, the algorithms used to evaluate the company in the various dimensions of the Integrated Innovation Model (IIM) are simple averages, and comparisons are made between averages and also taking into account the standard deviation.

For example, about the degree of market pressure, the report gives the following information, depending on the average value obtained:

| Average | Text |
|---|---|
| [0, 1[ | Your product is in a marketplace that is characterized |
| | by very little competitive pressure. Lucky for you! |
| [1, 2[ | Your product is in a marketplace that is characterized |
| | by little competitive pressure. Although there is some |
| | creeping competition, you should consider yourself |
| | lucky! |
| [2, 3[ | Your product is in a marketplace that is characterized |
| | by little competitive pressure with few rival |
| | offerings of a similar product. But watch out for the |
| | creeping competition. |
| [3, 4[ | Your product is in a marketplace that is characterized |
| | by low competitive pressure without a great deal of |
| | immediate rivalry, but that may soon change. |
| [4, 5[ | Your product is in a marketplace that is characterized |
| | by the existence of some competitive pressure, which |
| | can be classified as being from low to medium. There |
| | exist other rival firms who are also in your |
| | marketplace.. |
| [5, 6[ | Your product is in a marketplace that is characterized |
| | by the existence of competitive pressure, which can be |
| | classified as being medium without being high. There |
| | are other rivals who are striving to compete in your |
| | marketplace. |
| [6, 7[ | Your product is in a marketplace that is characterized |
| | by the existence of competitive pressure, which can be |
| | classified as being between medium to high. There |
| | exists some degree of rivalry as your product jostles |
| | with competition from other rivals. |
| [7, 8[ | Your product is in a marketplace that is characterized |
| | by the existence of competitive pressure, which can be |
| | classified as being high. There exists a great deal of |
| | rivalry as your product jostles with competition from |
| | other rivals. |
| [8, 9[ | Your product is in a marketplace that is characterized |
| | by the existence of competitive pressure, which can be |
| | classified as being very high. There exists a great |
| | deal of rivalry as your product jostles in a crowded |
| | marketplace. |
| [9, 10[ | Your product is in a marketplace that is characterized |
| | by the existence of competitive pressure, which can be |
| | classified as being extremely high. In an intensely |
| | competitive marketplace, you definitely have to |
| | rethink your survival strategy. |

The same process, with other text, is made for the other two dimensions of the model (degree of differentiation/innovation and outcome).

The intersection between variables is also relevant. For example, connecting the information between market pressure and differentiation/innovation give us the position in the archetype space, following this criteria:

| Average | Average | |
|---|---|---|
| Market | Degree | |
| Pressure | Diff/Innov. | Text |
| <5 | <5 | Based on your assessment test, we |
| | | believe that your product is a bear, |
| | | characterised by low market pressure and |
| | | low differentiation strategy. |
| <5 | >=5 | Based on your assessment test, we |
| | | believe that your product is a wolf, |
| | | characterised by low market pressure and |
| | | high differentiation strategy. |
| >=5 | <5 | Based on your assessment test, we |
| | | believe that your product is a sheep, |
| | | characterised by high market pressure |
| | | and low differentiation strategy. |
| >=5 | >=5 | Based on your assessment test, we |
| | | believe that your product is a fox, |
| | | characterised by high market pressure |
| | | and high differentiation strategy. |

Then the software compares the subdimensions with the respective dimension average (also including the standard deviation, sd.). For example, comparing the degree of market pressure (X) with the respective subdimensions—Competition (X_{A}), Client pressure (X_{B}) and Price Pressure (X_{C}), give us the following information:

| | |
|---|---|
| X − sd < X_{A} < X + sd | We verified that for your product, when compared |
| | with the global degree of competitive pressure |
| | of firm, competition has a similar value, in |
| | terms of that competitive pressure. |
| X + sd < X_{A} < X + | We verified that for your product, when compared |
| 2sd | with the global degree of competitive pressure |
| | of firm, competition shows a value bigger than |
| | average, showing that competition is one of the |
| | major sources of competitive pressure. |
| X_{A} > X + 2sd | We verified that for your product, when compared |
| | with the global degree of competitive pressure |
| | of firm, competition shows a value that is much |
| | bigger than average, showing that competition |
| | has a great role on the competitive pressure |
| | faced by firm. |
| X − 2sd < X_{A} < X − | We verified that for your product, when compared |
| sd | with the global degree of competitive pressure |
| | of firm, competition shows a value smaller than |
| | average, showing that competition is one of the |
| | major sources of competitive pressure. |
| X_{A} < X − 2sd | We verified that for your product, when compared |
| | with the global degree of competitive pressure |
| | of firm, competition shows a value that is much |
| | smaller than average, showing that competition |
| | has not a great role on the competitive pressure |
| | faced by firm. |

The same process is next made for the other subdimensions of each dimension.

The comparison between subdimensions of different dimensions is also made, like this case, for example:

Clients' Perception (Y_{B}) vs. Prestige (Z_{C})

| Average | Average | |
|---|---|---|
| Y_{B} | Z_{C} | Text |
| <5 | <5 | From the relation between client's perception |
| | | and prestige, we conclude that the product has |
| | | a position in a zone where the degree of |
| | | differentiation percept by clients and |
| | | prestige are low. Clients don't experience |
| | | differences between yours and concurrence's |
| | | product, and product also doesn't have a good |
| | | result in prestige. |
| <5 | >=5 | From the relation between clients' perception |
| | | and prestige, we conclude that the product has |
| | | a position in a zone where the degree of |
| | | differentiation percepted by clients is low |
| | | and prestige is high. It could be a product |
| | | that is not much differentiated but which |
| | | brand strength could have influence in its |
| | | prestige. |
| >=5 | <5 | From the relation between clients' perception |
| | | and prestige, we conclude that the product has |
| | | a position in a zone where the degree of |
| | | differentiation percepted by clients is high |
| | | and prestige is low. Maybe there is a lack of |
| | | capacity to increase product's image with |
| | | clients. |
| >=5 | >=5 | From the relation between clients' perception |
| | | and prestige, we conclude that the product has |
| | | a position in a zone where the degree of |
| | | differentiation percepted by clients and |
| | | prestige are high. The capacity of |
| | | differentiation and efforts to gain prestige |
| | | with clients was a success. |

And finally, the comparison between the firm and the industry is made, with similar information.

Output graphic representation—An example of an output:

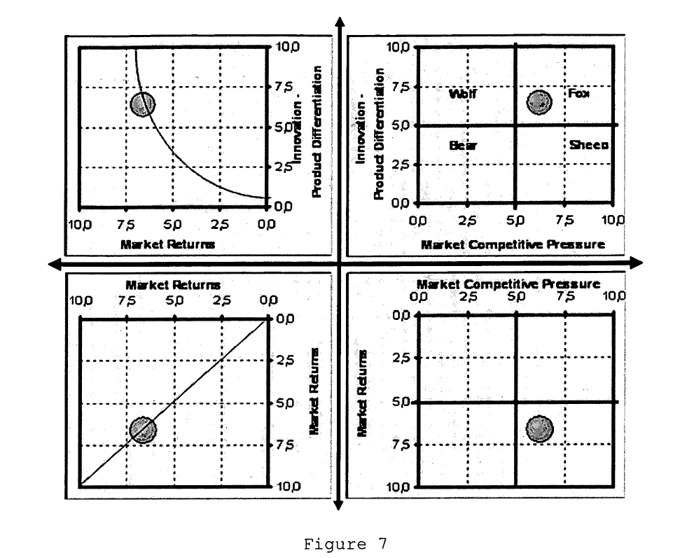

The first step is to identify the position of the firm in the Integrated Innovation Model (IIM), according to the averages of each variable. That position is automatically identified in the graph, FIG. 7, with the four different dimensions and associated environments in the integrated model.

Following this graph the corresponding text explains that position, for example:

Product is in a marketplace that is characterized by the existence of competitive pressure, which can be classified as being between medium to high. There exists some degree of rivalry as product jostles with competition from other rivals;

Product differentiation can be classified as being between medium to high.

Based on assessment test, we believe that product is a fox, characterised by high market pressure and high differentiation strategy (Note: This is not the case, but the automatic report can identify situations where one product could be in the margin of one archetype, explaining also this situation);

With regards to position in the outcome space, the results are excellent. This is the payoff that firm is receiving from being a fox and because of its focus on differentiation. Looking to constantly keep this focus and not let competition get firm is a task of the firm;

In the market space, product is located in space characterized by high market competitive pressure and high market outcome. As mentioned earlier, perhaps given the higher degree of competition you are facing, being a fox you are paying the price of not enjoying higher market outcome. Look to create market niches.

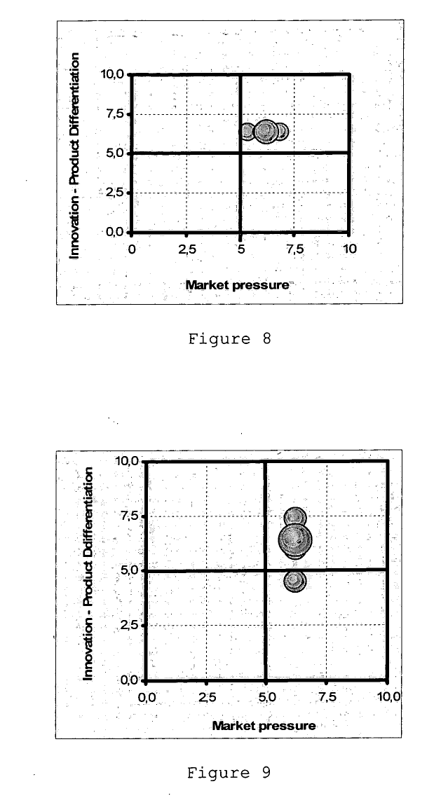

We saw that this firm faces a competitive market. But there are many dimensions of competition, as identified before. In the diagnosis where there is competition from other firms, client's pressure and price pressure as dimensions of competitiveness. In order to verify if these three dimensions have all the same degree of competition one needs to analyse FIG. 8 and FIG. 9 where:

It is verified that for the product, when compared to the global degree of competitive pressure of firm, competition has a similar value, in terms of competitive pressure;

It can also be seen that, when compared to the global degree of competitive pressure of a firm, client pressure has a similar value, in terms of that competitive pressure;

Finally, is is verified that, when compared to the global degree of competitive pressure on a firm, price pressure has a similar value, in terms of that competitive pressure;

The difference between dimensions that comprise of the degree of competitive pressure is not significant, as the three dimensions show similar competitive pressure;

It can also be said that the factor which is predominant is competition;

On other hand, the factor that has less importance is client pressure.

The same kind of conclusion and analysis could be made for the other two subdimensions differentiation and results:

About product differentiation, we verified that, comparing with global differentiation, the sustainability of that differentiation presents a similar value;

Passing for clients, and comparing their perception of differentiation about the product, that perception shows a similar value when compared with the global differentiation value;

About the comparison between differentiation and firm's investment, investment presents a smaller value than average, showing that it is not an important source of differentiation;

The latter considered as a factor of differentiation—knowledge. Comparing the knowledge necessary for differentiation and the global degree of differentiation it can be concluded that both values are similar;

As can be seen, the difference between dimensions that compose the degree of differentiation of the product is relevant, showing some dispersion in figure;

One can also say that the factor that accounts for less in this example, on differentiation is its investment.

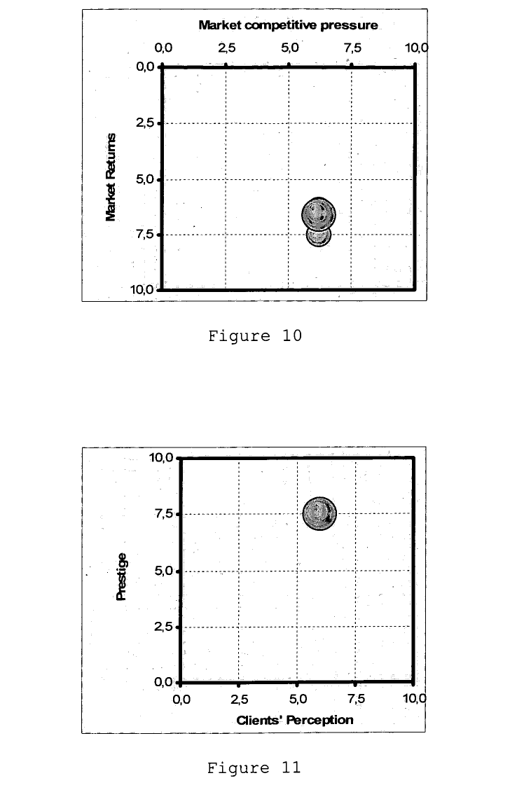

Finally, we have the comparison between results dimensions, FIG. 10:

Comparing global products result and market share in particular, one can see that both present similar values;

When comparing global results and financial performance we conclude that they present similar values;

Finally comparing global results and product's prestige (in this case) they present similar values;

As can be seen, the difference between the measures used to analyse results is high, as the dispersion in figure reveals;

One can also say that the factor which is more important to determine results is the prestige associated with the product;

On the other hand, the market share is the variable that has less importance in determining results (if that is the case).

Some variables are also important for the firm, to recognize if there is some connection between them.

From the relation between client's perception and prestige, we conclude that the product has a position in a zone where the degree of differentiation acknowledged by clients and prestige are high, as seen in FIG. 11. The capacity of differentiation and efforts to gain prestige with clients was a success.

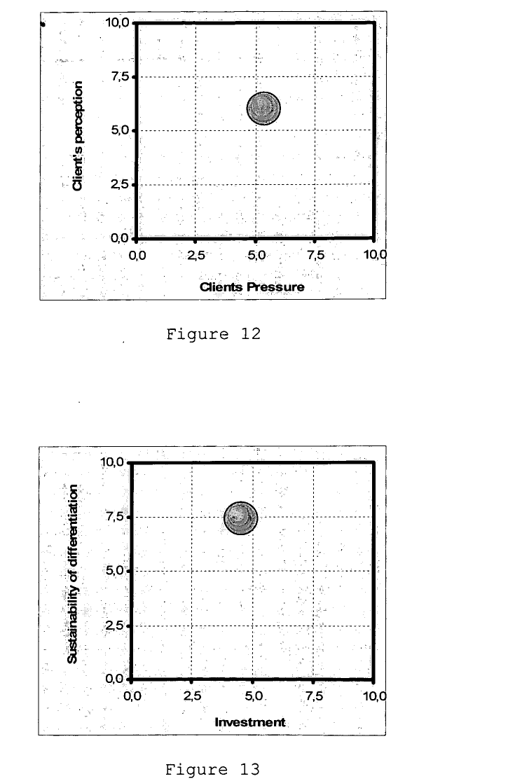

Comparing the degree of competitive pressure that clients perceive in the product and their perception about its differentiation, one can see that the product has a position where both variables are high, as seen in FIG. 12. Despite clients have a great perception about product's differentiation they continue to have capacity to pressure it.

Comparing between sustainability of differentiation and investment, one concludes that the product is in a position where sustainability is high and investment is low, as seen in FIG. 13. We may be in the presence of a product with a strong brand image, where substantial investments were made in the past.

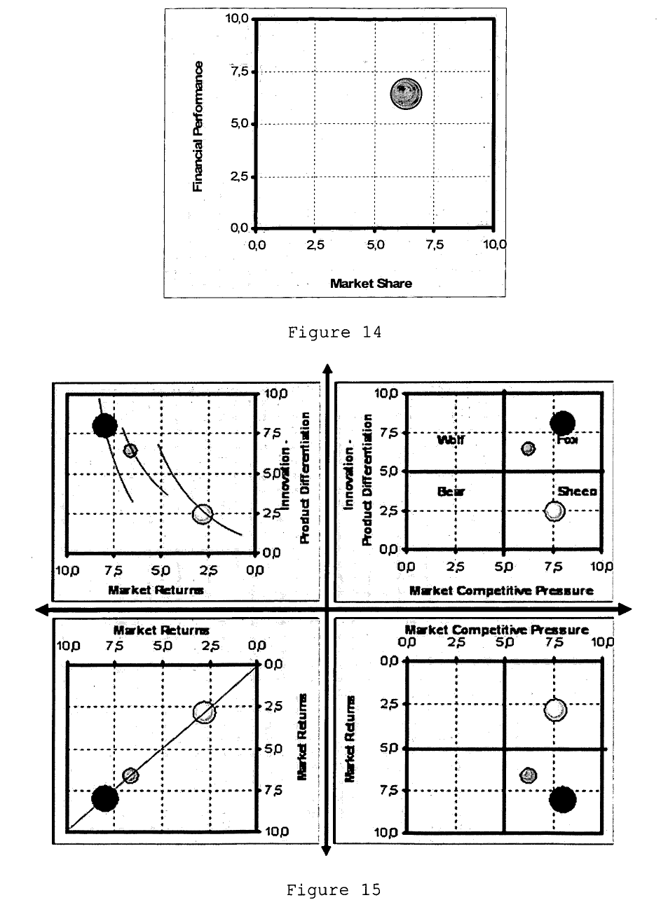

Taking into account market share and financial performance, the product is in a position where market share and financial performance are both high, as seen in FIG. 14. In this case, associated with a high market share, we have also high financial indicators.

With the answers obtained from a substantial number of firms, it is possible to analyse the behaviour of one firm with its correspondent cluster (in the same sector) Data collection of the cluster could be recorded and information used based on the averages of that cluster.

Thus all the previous analyses could be done comparing the situation of the firm with respect to its cluster (and also with respect to the market leader). However, in this report, we just made the direct comparison between firm and cluster, as seen in FIG. 15 (white bubble—market; black bubble—leader; gray bubble—firm), where:

Industry is characterized by the existence of competitive pressure, which can be classified as being high;

Industry has a relatively low degree of differentiation;

We think that industry is in the sheep archetype, characterized by a high degree of competitive pressure and low product differentiation;

About industry results, they have a reduced level of desired outcome in general;

In the market space, industry is in a position of high competitive pressure and low market results.

Then it is possible to analyse the behaviour of the firm comparing it to the cluster average. For instance:

Your product has less competitive pressure than the industry;

The product is more differentiated than the industry;

Finally, your results are greater than the industry average.

The above are examples of some general results and then detailed analysis can be made based on the data information retrieved.

This presentation of the method which evaluates the position of a firm in the market according to its strategy of differentiation is made as a not limiting example that can be subject to modifications and variations by of an expert in the field, which is covered by the scope of the present invention, as defined in the following claims.

1. A method which evaluates the position of a firm in the market according to its strategy of differentiation, based on an Integrated Innovation Model (IIM), wherein, comprises essentially the following steps:
application of a data recovery system, preferably a questionnaire, to the key players of the firm (for example, managers, directors, other workers, clients and product consumers), with a predetermined number of questions;
identification of the position of the firm in the four spaces of the IIM model which are:
the Archetype Space (combines the degree of competitive pressure and the degree of differentiation and innovation);
the Strategy Space (combines the degree of differentiation and innovation with the results);
the Outcome Space (combines two dimensions of results); and
the Market Space (combines results with the degree of competitive pressure faced by firm),
classification of the enterprise in the Archetype Space which has essentially the following archetypes:
Wolf (high differentiation, low competition);
Fox (high differentiation and competition);
Bear (low differentiation and competition); and
Sheep (low differentiation and high competition),
process of comparisons essentially comprising:
comparing the position of each enterprise with the industry in each of the three dimensions and in each of the four spaces;
then comparing each of the firm subdimensions with the industry subdimensions results; and
finally viewing if the behaviour of subdimensions is equal when comparing the results of firm with the results of the industry;
storage of results and averages within the respective industry to allow comparing the particular position of one firm.
creation of a report with specific solutions according to the results in each of the previous steps and the type of report chosen.

2. The method according to claim 1, wherein the use of information gathered to describe several dynamics of the IIM that comprises essentially the following steps:
find the position of the firm in each one of the four spaces of the IIM model;
assume one behavioural relation between differentiation and results, according to the position in the strategy Space, where this relation depends on the result-innovation elasticity and of the position of the curve the process;
perform some questions that will simulate some scenarios that correspond to the different dynamics allowed in the model. These simulations could be related to the entrance of more firms in the market, impact of greater innovation investment (continuous innovation made by the incumbent firm, emergence of radical/disruptive innovations or the natural consequence of the life cycle in the market, among other dynamics.

3. The method according to claim 1, wherein the implementation of this method is made by software means, that run in a computer and comprises essentially:
a visual environment where the questionnaire is made available to answer;
a visual environment where the means of identification of the firm, in the four spaces of the IIM model, can be seen and printed;
a visual environment where the report, with specific solutions according to the results, can be seen and printed.

4. The method according to claim 1, wherein the three dimensions degree of competitive pressure, degree of differentiation/innovation and outcome are divided in subdimensions according with groups of questions where:
the degree of competitive pressure is composed by concurrence, clients and Prices;
the degree of differentiation/innovation is composed by sustainability of differentiation, client's perception, investment and knowledge; and
outcome is composed by market share, financial performance and prestige;
and then each of these subdimensions is compared with the respective dimension and can also be treated as a variables, even those which are used in different dimensions, to be related and displayed.

5. The method according to claim 1, wherein the related subdimensions are essentially:
client's perception vs client's degree of pressure;
client's perception vs prestige;
investment in differentiation vs sustainability of differentiation; and
market share vs financial performance.

6. The method according to claim 1, wherein it compares the behavior of the degree of competitive pressure with the different subdimensions that compose that degree to give information to the management from each one of the four spaces used in the model.

7. The method according to claim 1, wherein it compares the behavior of the degree of innovation/differentiation with the different subdimensions that compose that degree to give information to the management from each one of the four spaces used in the model.

8. The method according to claim 1, wherein it compares the behavior of the degree of outcomes with the different subdimensions that compose that degree to give information to the management from each one of the four spaces used in the model.

9. A process to recover information about different firms and to compare individual firm's results with information of industry according to claim 1, based on a questionnaire where all questions are evaluated from 0 to 10, where 0 is the minimum value and 10 is the maximum value.

10. A process to compare results for different subdimensions of each three dimensions according to claim 1, and give information for management based on simple averages, and comparisons made between averages and also taking into account the standard deviation.

11. A software structure to recover information about different firms and to compare individual firm's results according to claim 3, which essentially comprises the following:
“Diagnostic” menu that makes the diagnostic for the firm, intra-firm, cluster and the organization;
“Simulations” menu that explores the dynamics inherent to the IIM, where the user is asked about some type of possible dynamics, for example new entrants in the industry, if an innovative product will be copied or an entrance from a disruptive product;
“Entrepreneurship & Innovation” menu that helps the user to create a new firm; here the user supplies the information necessary establish the market degree of competition is and then several scenarios are simulated.
“Example” menu that shows an example of a questionnaire previously prepared, while “Help” will serve as a framework to help users how to navigate in this software;
“About us” gives information about the model, since the origins of the model, to the questions that are used, to the methods of data recovering and also to help users to choose if they are interested in one or more diagnostics.
